(19) United States
(12) Patent Application Publication
(10) Pub. No.: US 2026/0295999 A1
(43) Pub. Date: Oct. 1, 2026

(54) LIQUID DROPLET EJECTION DEVICE, LIQUID DROPLET EJECTION METHOD, AND NON-TRANSITORY COMPUTER-READABLE STORAGE DEVICE CONTAINING COMPUTER-EXECUTABLE INSTRUCTIONS THEREFOR

(71) Applicant: BROTHER KOGYO KABUSHIKI KAISHA, Nagoya (JP)

(72) Inventor: Kazuya SEKO, Nagoya (JP)

(73) Assignee: BROTHER KOGYO KABUSHIKI KAISHA, Nagoya (JP)

(21) Appl. No.: 19/573,064

(22) Filed: Mar. 20, 2026

(30) Foreign Application Priority Data
Mar. 27, 2025 (JP) 2025-053554

(51) Int. Cl. B41J 2/045

(52) U.S. Cl. CPC B41J 2/04563; B41J 2/04581; B41J 2202/08

(57) ABSTRACT

A liquid droplet ejection device includes an ejection head with a flow path member having multiple nozzles and pressure chambers communicating with the nozzles. Actuators are disposed on the upper surface of the flow path member to apply ejection pressure to liquid in the pressure chambers. A frame member is arranged opposite to the flow path member with respect to the actuators. A heat generating member is accommodated in the frame member to generate heat. A temperature sensor detects a representative temperature of the actuators as a whole. A controller obtains the representative temperature, determines whether a difference between the representative temperature and an initial set temperature, which is a predetermined target temperature, is equal to or greater than a threshold, and, when the difference is less than the threshold, executes a first adjustment process to raise the target temperature and activate the heat generating member before printing starts.

### REFERENCE TO RELATED APPLICATIONS

This application claims priority from Japanese Patent Application No. 2025-053554 filed on Mar. 27, 2025. The entire content of the priority application is incorporated herein by reference.

### TECHNICAL FIELD

The present disclosure relates to a liquid droplet ejection device, a liquid droplet ejection method, and a non-transitory computer-readable storage medium storing instructions executable by a processor to implement the method, for example, in an inkjet printer.

### BACKGROUND ART

In a typical inkjet printer, an ejection head includes a flow path substrate formed by stacking multiple plates, a vibration plate disposed on the flow path substrate, and multiple actuators disposed on the vibration plate. A common electrode is shared among the actuators, and a temperature sensor is disposed on the common electrode to detect its temperature. The ink flowing through the flow paths in the flow path substrate is heated to a predetermined temperature by a heater.

### SUMMARY

When printing begins, the actuator generates heat through its operation, and this heat is transferred to the ink within the flow path, causing the ink temperature to rise. If the temperature sensor could accurately detect the actual temperature of the ink in real time, the operating voltage of the actuator could be controlled based on the ink temperature, allowing proper formation of ink droplets. However, there is a discrepancy between the temperature detected by the sensor and the actual temperature of the ink. This discrepancy tends to be particularly large immediately after printing starts, because the ejection head is still at a relatively low temperature. As a result, the operating voltage of the actuator cannot be appropriately controlled, and the ejected ink droplets tend to be smaller than the designed size. Consequently, the ink density per unit area of an image on the recording medium immediately after the start of printing becomes lower than the designed value, resulting in density unevenness between the density of an image portion printed immediately after printing begins and the density of an image portion printed after a certain period of time has elapsed.

According to aspects of the present disclosure, a liquid droplet ejection device includes an ejection head including a flow path member and a plurality of actuators. The flow path member is formed with a plurality of nozzles, liquid droplets being ejected from the plurality of nozzles toward a recording medium, a plurality of pressure chambers that communicate with the plurality of nozzles. The plurality of actuators are disposed on an upper surface of the flow path member and configured to apply ejection pressure to the liquid within the pressure chambers. The liquid droplet ejection device also includes a frame member disposed on a side opposite to the flow path member with respect to the actuators, a heat generating member accommodated in the frame member and configured to generate heat, a temperature sensor configured to detect a representative temperature indicative of a temperature of the actuators as a whole, and a controller. The controller is configured to obtain the representative temperature detected by the temperature sensor, determine whether a difference between the representative temperature and an initial set temperature, which is a predetermined target temperature, is equal to or greater than a threshold value, and when the difference is less than the threshold value, execute a first adjustment process. In the first adjustment process, the controller adjusts the target temperature to a first adjustment temperature, the first adjustment temperature being higher than the initial set temperature, and causes the heat generating member to generate heat before start of printing.

According to aspects of the present disclosure, a liquid droplet ejection method using a liquid droplet ejection device is provided. The liquid droplet ejection device includes an ejection head including a flow path member and a plurality of actuators. The flow path member is formed with a plurality of nozzles, liquid droplets being ejected from the plurality of nozzles toward a recording medium, and a plurality of pressure chambers that communicate with the plurality of nozzles. The plurality of actuators are disposed on an upper surface of the flow path member and configured to apply ejection pressure to the liquid within the pressure chambers. The device also includes a frame member disposed on a side opposite to the flow path member with respect to the actuators, a heat generating member accommodated in the frame member and configured to generate heat, and a temperature sensor configured to detect a representative temperature indicative of a temperature of the actuators as a whole. The method includes obtaining the representative temperature detected by the temperature sensor, determining whether a difference between the detected temperature and an initial set temperature, which is a predetermined target temperature, is equal to or greater than a threshold, and when the difference is less than the threshold, adjusting the target temperature by change the target temperature to a first adjustment temperature that is higher than the initial set temperature, and causing the heat generating member to generate heat before start of printing.

According to aspects of the present disclosure, a non-transitory computer-readable storage medium for a liquid droplet ejection device is provided. The liquid droplet ejection device includes an ejection head including a flow path member and a plurality of actuators. The flow path member is formed with a plurality of nozzles. Liquid droplets are ejected from the plurality of nozzles toward a recording medium, and a plurality of pressure chambers that communicate with the plurality of nozzles. The plurality of actuators are disposed on an upper surface of the flow path member and configured to apply ejection pressure to the liquid within the pressure chambers. The liquid droplet ejection device also includes a frame member disposed on a side opposite to the flow path member with respect to the actuators, a heat generating member accommodated in the frame member and configured to generate heat, and a temperature sensor configured to detect a representative temperature indicative of a temperature of the actuators as a whole. The non-transitory computer-readable storage medium contains computer-executable instructions which cause, when executed by a computer of the liquid droplet ejection device, the liquid droplet ejection device to execute obtaining the representative temperature detected by the temperature sensor, determining whether a difference between the detected temperature and an initial set temperature, which is a predetermined target temperature, is equal to or greater than a threshold, and when the difference is less than the threshold, adjusting the target temperature to a first adjustment temperature that is higher than the initial set temperature, and causing the heat generating member to generate heat before start of printing.

### BRIEF DESCRIPTION OF DRAWGINS

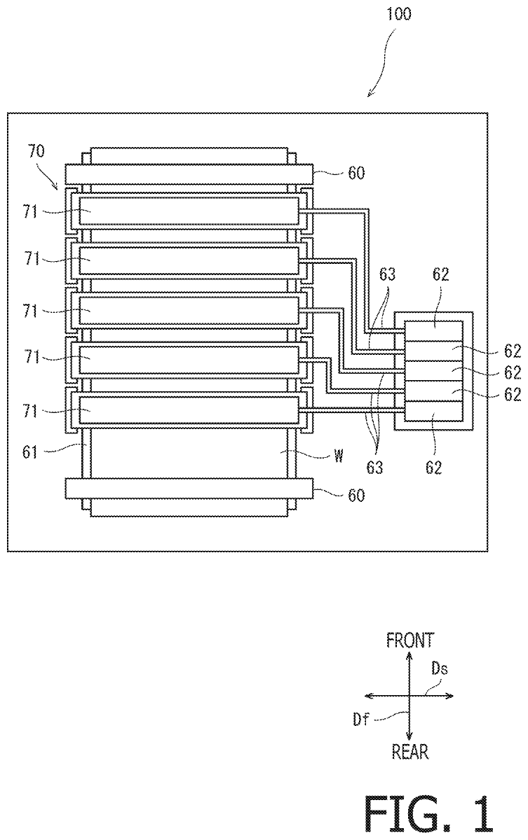

FIG. 1 schematically illustrates an example configuration of a liquid droplet ejection device according to an embodiment.

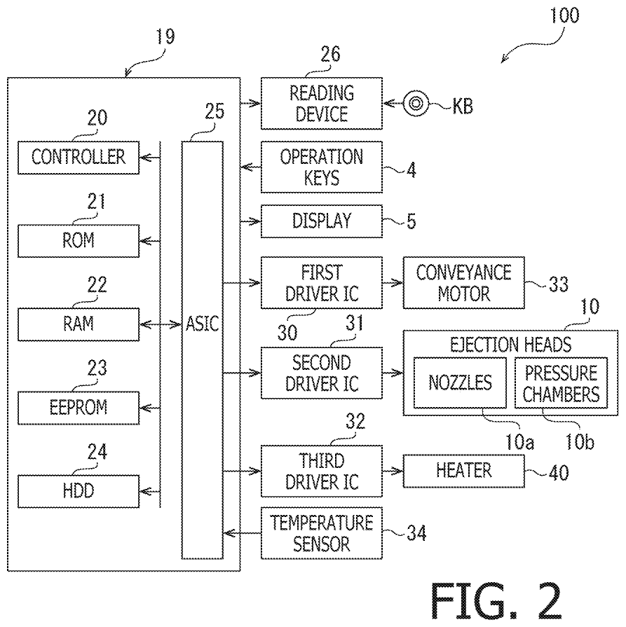

FIG. 2 is a block diagram illustrating example components of the liquid droplet ejection device shown in FIG. 1.

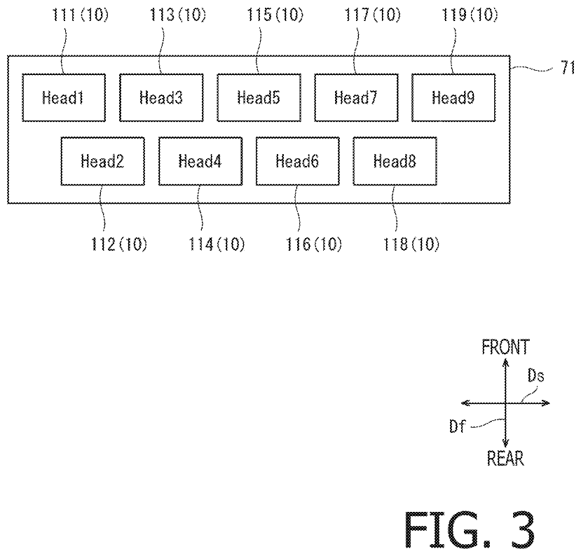

FIG. 3 is a bottom view illustrating the configuration of a line head of the device shown in FIG. 1.

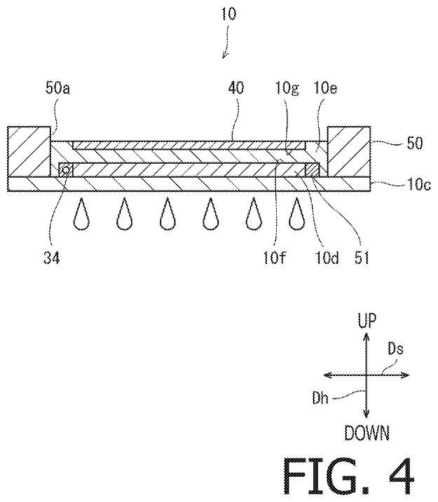

FIG. 4 is a cross-sectional view illustrating the structure of an ejection head.

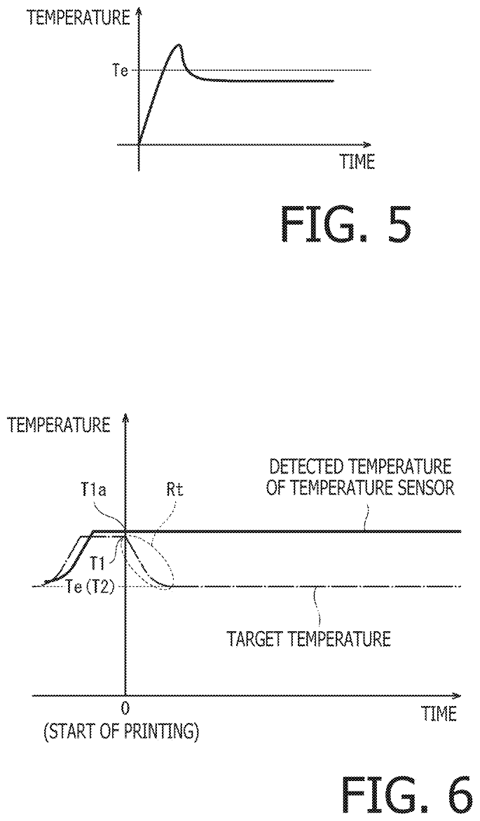

FIG. 5 is a graph illustrating an overshoot in the temperature of the actuator.

FIG. 6 is a graph illustrating time-based changes in a target temperature and a detected temperature of a temperature sensor.

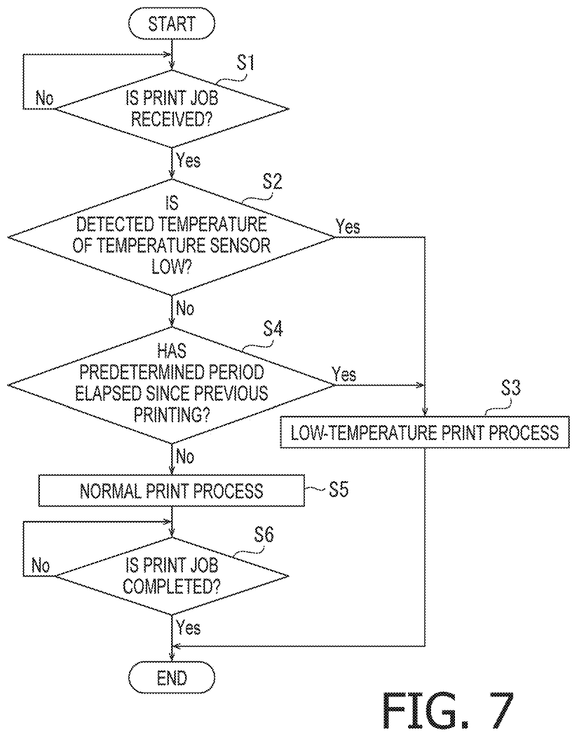

FIG. 7 is a flowchart illustrating an example print process executed by the liquid droplet ejection device.

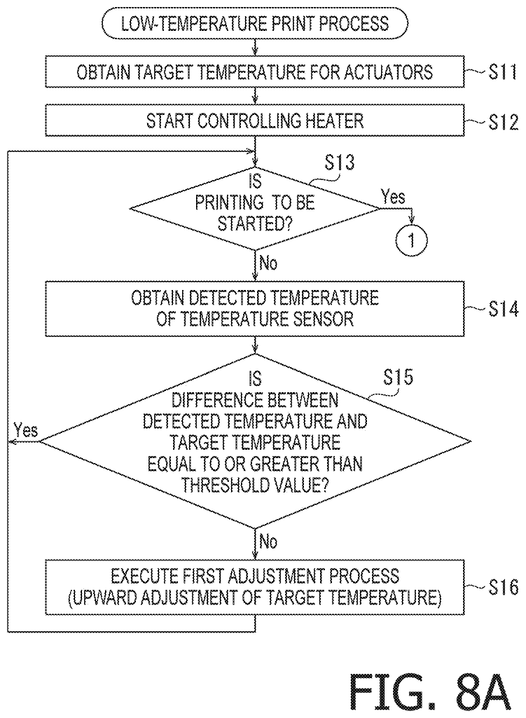

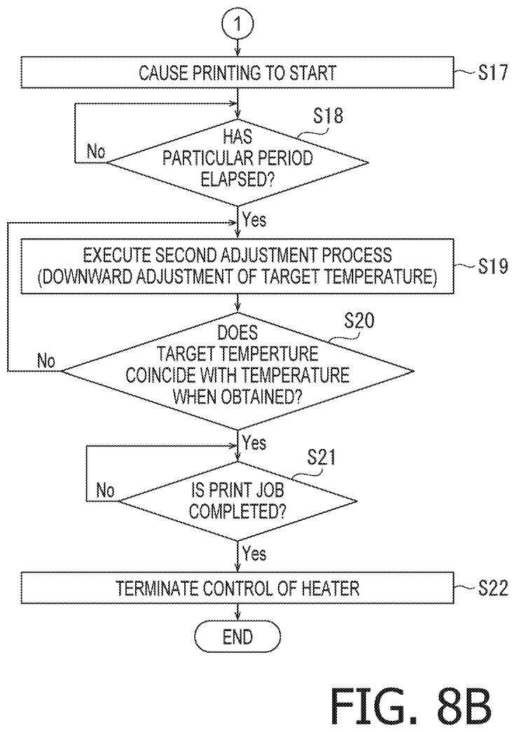

FIGS. 8A and 8B show a flowchart illustrating a subroutine of an example low-temperature print process corresponding to the flowchart in FIG. 7.

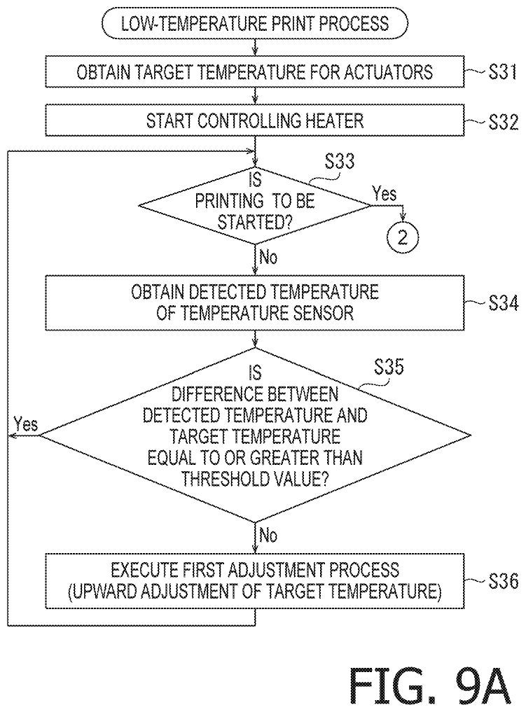

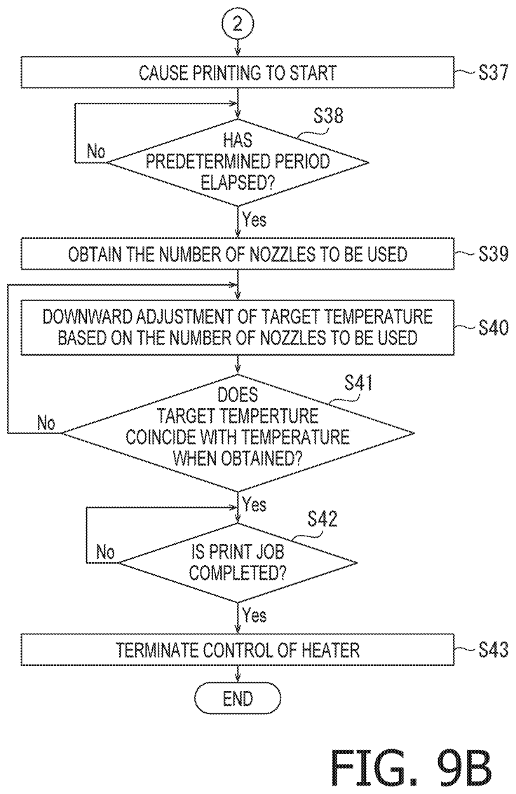

FIGS. 9A and 9B show a flowchart illustrating a subroutine of another example low-temperature print process corresponding to the flowchart in FIG. 7.

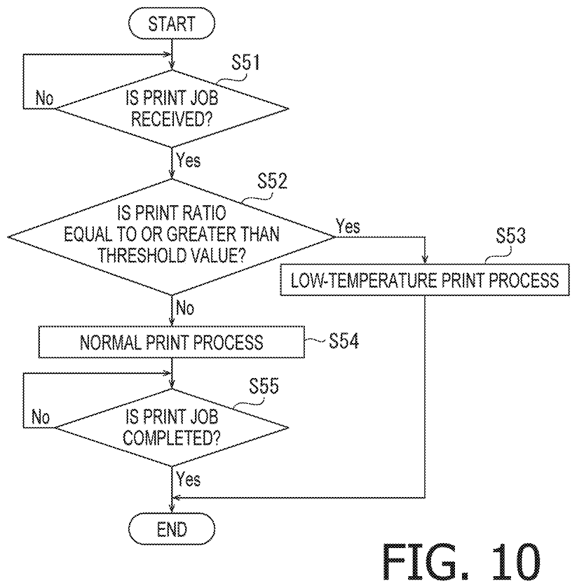

FIG. 10 is a flowchart illustrating another example print process executed by the liquid droplet ejection device.

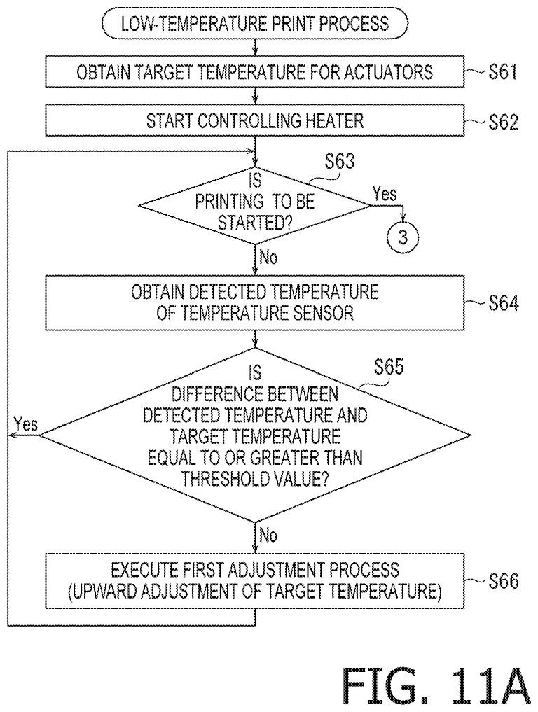

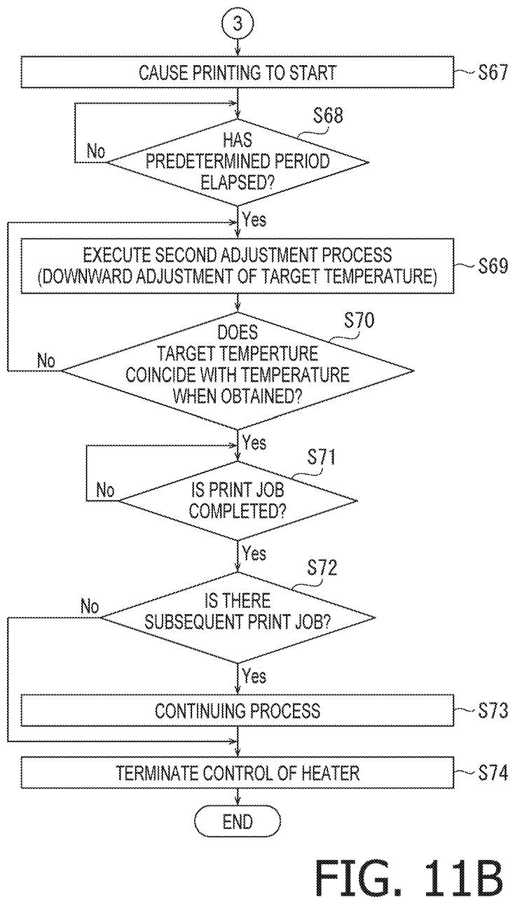

FIGS. 11A and 11B show a flowchart illustrating a subroutine of yet another low-temperature print process corresponding to the flow in FIG. 7.

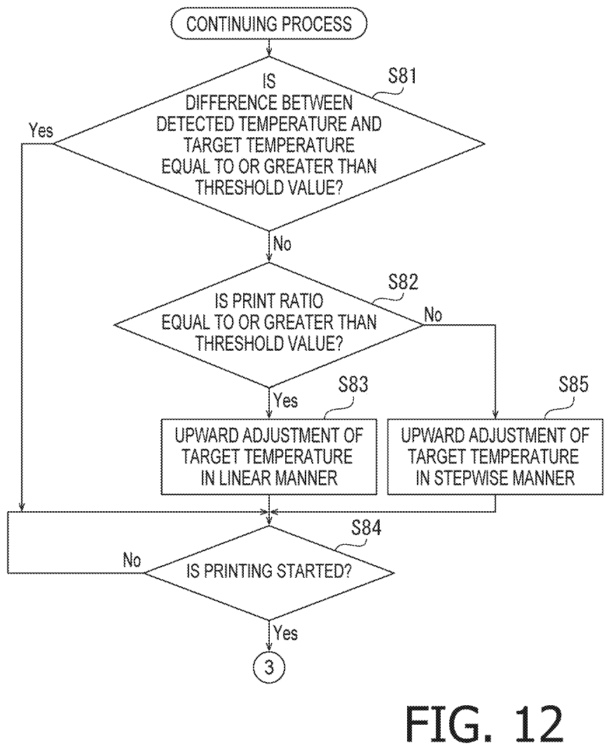

FIG. 12 is a flowchart illustrating a subroutine of a continuing process corresponding to the flow in FIG. 11B.

### DESCRIPTION

Hereinafter, a liquid droplet ejection device according to aspects of the present disclosure will be described with reference to the drawings. It is to be understood that the liquid droplet ejection device described below is merely one example embodiment, and that the present disclosure is not limited to the specific embodiment set forth herein. Various modifications, additions, and omissions may be made without departing from the spirit and scope of the present disclosure.

FIG. 1 illustrates an example configuration of a liquid droplet ejection device 100 according to a first embodiment. The liquid droplet ejection device 100 is, for example, of a line-head type. However, the device is not limited to the line-head type and may alternatively be of a serial-head type.

In FIG. 1 and the drawings that follow, three mutually orthogonal directions are defined as a first direction Df, a second direction Ds, and a third direction Dh. In the present embodiment, the first direction Df corresponds to a conveying direction of a recording medium W; the second direction Ds corresponds to a direction intersecting the conveying direction; and the third direction Dh corresponds to a vertical (up-down) direction.

In the following description, the first direction Df will be referred to as the conveying direction, the second direction Ds as the intersecting direction, and the third direction Dh as the vertical direction. In FIG. 1, the front side corresponds to one end of the conveying direction Df, and the rear side corresponds to the opposite end. That is, the recording medium W is conveyed from the rear side toward the front side along the conveying direction Df.

As shown in FIG. 1, the liquid droplet ejection device 100 includes a line head group 70, a pair of conveyance rollers 60, a platen 61, a plurality of reservoirs 62, and a plurality of tubes 63.

The line head group 70 includes, for example, five line heads 71. Each line head 71 corresponds to a respective ink color. In the present embodiment, the five line heads 71, arranged from the front side in the conveying direction Df, are configured to eject black ink, yellow ink, magenta ink, cyan ink, and white ink, respectively.

It should be noted that the line head 71 for ejecting white ink is not essential. Alternatively or optionally, a line head 71 configured to eject clear ink or a special color ink may be provided. The line heads 71 are arranged at equal intervals in the conveying direction Df, and each line head 71 extends in the intersecting direction Ds. Each line head 71 includes a plurality of ejection heads 10 (see FIG. 3).

The platen 61 is configured to support the recording medium W, such as a printing sheet, from below. For example, the platen 61 is formed of a rectangular plate member whose longer sides extend along the conveying direction Df.

The pair of conveying rollers 60 extend in the intersecting direction Ds. The size of each conveying roller 60 in the intersecting direction Ds is slightly greater than the size of the recording medium W in the intersecting direction Ds. One of the pair of conveying rollers 60 is connected to a conveyance motor 33 (see FIG. 2) which will be described later, and is arrange on one side, in the conveying direction Df, of the platen 61. The other of the pair of conveying rollers 60 is arranged on an opposite side of the platen 61. When the conveyance motor 33 is driven, the conveying rollers 60 rotate, thereby the recording medium W on the platen 61 being conveyed in the conveying direction Df.

The reservoirs 62 are configured to store ink. The reservoirs 62 are provided respectively for different types of ink. For example, five reservoirs 62 are provided to store black, yellow, magenta, cyan, and white inks, respectively. By ejecting black, yellow, magenta, and cyan ink droplets onto the recording medium W, a color image is formed. In addition, by ejecting white ink droplets onto the recording medium W, a base layer is formed.

The tubes 63 are disposed, each connecting a corresponding reservoir 62 to a plurality of ejection heads 10 disposed in a corresponding line head 71.

FIG. 2 is a block diagram illustrating an example configuration of the liquid droplet ejection device 100 shown in FIG. 1. As illustrated in FIG. 2, the liquid droplet ejection device 100 includes operation keys 4, a display 5, ejection heads 10, a controller unit 19, a reading device 26, first, second, and third driver ICs 30, 31, and 32, a conveyance motor 33, a temperature sensor 34, and a heater 40. It is noted that the heater 40 serves as an example of a heat generating member according to the present disclosure.

It should be understood that, throughout this specification and the claims, the term “unit” is intended to refer to hardware-based components, assemblies, or structural elements, unless expressly indicated otherwise. In this context, “unit” may refer to a discrete hardware component or device comprising one or more physical elements.

The operation keys 4 are configured to receive user input. The display 5 is implemented, for example, as a touch panel and is configured to display various types of information. A portion of the display 5 also functions as operation keys. The controller unit 19 is configured to execute printing functions and to control the display 5 based on input from the operation keys 4 and/or external input received via a communication interface (not shown).

The ejection heads 10 are, for example, inkjet heads. As schematically illustrated in FIG. 4, each ejection head 10 includes a flow path member 10c having a plurality of nozzles 10a, a plurality of pressure chambers 10b, each of which is in communication with a corresponding nozzle 10a, and a plurality of actuators 10d each corresponding to a respective one of the plurality of pressure chambers 10b. The actuators 10d are disposed on an upper surface of the flow path member 10c and are configured to apply ejection pressure to the ink contained in the respective pressure chambers 10b. When ejection pressure is applied to the ink in the pressure chambers 10b by the actuators 10d, ink droplets are ejected from the nozzles 10a toward the recording medium W. As a result, a desired image is printed on the recording medium W.

The controller unit 19 includes a controller 20 including a CPU, storage devices such as a ROM 21 (Read Only Memory), a RAM 22 (Random Access Memory), an EEPROM 23 (Electrically Erasable Programmable Read-Only Memory), and an HDD 24 (Hard Disk Drive), and an ASIC 25 (Application Specific Integrated Circuit). The controller 20 is connected to each of the above-mentioned storage devices and is configured to control the first, second, and third driver ICs 30, 31, and 32, the display 5, and the reading device 26.

The controller 20 executes various functions by executing a predetermined liquid droplet ejection program stored in the ROM 21. The controller 20 may be implemented as a single processor within the controller unit 19, or as a plurality of processors that operate cooperatively. In the present disclosure, the controller 20 corresponds to a computer, and implements the functions of an acquisition unit, a determination unit, and a correction unit by executing the liquid droplet ejection program.

The liquid droplet ejection program may be read from a computer-readable storage medium KB, such as a magneto-optical disk or a USB flash memory, by the reading device 26 and stored in the ROM 21. Alternatively, the program may be downloaded via a network such as the Internet and stored in the ROM 21.

The RAM 22 stores image data received from an external source and computation results produced by the controller 20. The EEPROM 23 stores various types of initial setting information entered by the user. The HDD 24 stores various types of information.

The ASIC 25 is connected to the first, second, and third driver ICs 30, 31, and 32. Upon receiving a print job from the user, the controller 20 outputs a print command to the ASIC 25 based on the liquid droplet ejection program. The ASIC 25 controls the first, second, and third driver ICs 30, 31, and 32 in accordance with the print command.

The controller 20 controls the first driver IC 30 to drive the conveyance motor 33, thereby moving the platen 61 in the conveying direction Df. The controller 20 also converts image data received from an external device into ejection data, which is print data used for ejecting ink droplets onto the recording medium W. Based on the ejection data, the controller 20 controls the second driver IC 31 to cause the ejection heads 10 to eject ink droplets onto the recording medium W. The controller 20 further controls the third driver IC 32 to cause the heater 40 to generate heat. In addition, the controller 20 receives a detected temperature, which is a temperature detected by the temperature sensor 34. Details of the heater 40 and the temperature sensor 34 will be described later.

FIG. 3 is a bottom view illustrating a configuration of the line head 71. As shown in FIG. 3, the line head 71 includes a plurality of ejection heads 10, for example, nine ejection heads 10 (e.g., Head1 111, Head2 112, . . . , Head9 119).

In the example shown in FIG. 3, among the nine ejection heads 10, five ejection heads 10 are arranged on a front side in the conveying direction Df, while the remaining four ejection heads 10 are arranged on a rear side in the conveying direction Df. The front-side ejection heads 10 include ejection heads 111, 113, 115, 117, and 119. The rear-side ejection heads 10 include ejection heads 112, 114, 116, and 118.

The front-side ejection heads 111, 113, 115, 117, and 119 are arranged at substantially equal intervals in the intersecting direction Ds. The rear-side ejection heads 112, 114, 116, and 118 are also arranged, in the intersecting direction Ds, at substantially equal intervals and are displaced by a predetermined distance, in the intersecting direction Ds, with respect to the respective front-side ejection heads. In other words, the multiple ejection heads 10 of the line head 71 are arranged in a staggered pattern in the intersecting direction Ds.

FIG. 4 is a cross-sectional view illustrating a configuration of the ejection head 10. As shown in FIG. 4, the ejection head 10 includes, in addition to the above-described flow path member 10c, actuators 10d, temperature sensor 34, and heater 40, a frame member 10e, a frame 50, and a potting material molded portion 51.

The frame 50 has a generally rectangular outer shape in plan view, with an opening 50a formed at its center. Thus, the frame 50 is shaped as a rectangular ring in plan view.

The frame member 10e is disposed within the opening 50a of the frame 50. The frame member 10e is disposed on a side opposite to the flow path member 10c with respect to the actuators 10d. The frame member 10e includes a recessed portion 10f, which is formed as an upward recess in part of its lower surface, and a recessed portion 10g, which is formed as a downward recess in part of its upper surface.

The potting material molded portion 51 is formed of, for example, urethane resin, silicone resin, or epoxy resin. The potting material molded portion 51 has a generally frame-like shape in plan view and is accommodated in the recessed portion 10f of the frame member 10e.

The heater 40 is accommodated in the recessed portion 10g of the frame member 10e. The heater 40 is, for example, a film heater. The heater 40 is electrically connected to the controller 20 via electric heating wires (not shown). The controller 20 controls the heat generation of the heater 40 by adjusting the current supplied to the heating wires. The heat generated by the heater 40 is transferred to the flow path member 10c via the frame member 10e and the actuators 10d, so that the frame member 10e, the actuators 10d, and the flow path member 10c are in a thermally balanced state. As a result, the ink inside the flow path member 10c is heated to a predetermined temperature.

The temperature sensor 34 is disposed within the potting material molded portion 51. The temperature sensor 34 is located at one end of the potting material molded portion 51 in the intersecting direction Ds. The temperature sensor 34 is, for example, a thermistor. The temperature sensor 34 detects the temperature of the actuators 10d via the potting material molded portion 51. The temperature of the actuators 10d to be detected refers to a representative temperature indicative of a temperature of the actuators 10d as a whole, for example, a temperature approximating an average temperature of the actuators 10d. The temperature sensor 34 is electrically connected to the controller 20. The controller 20 controls the supply current to the electric heating wires based on the temperature detected by the temperature sensor 34.

The actuators 10d are disposed on the upper surface of the flow path member 10c and are accommodated in the recessed portion 10f of the frame member 10e. Within the recessed portion 10f, the actuators 10d are located inward of the potting material molded portion 51. The actuators 10d are, for example, each a piezoelectric element. A known configuration is employed for the actuators 10d, which include a common electrode, a piezoelectric layer, and individual electrodes (not shown). The common electrode is disposed on a vibration plate (not shown) that covers an upper opening of each pressure chamber 10b in the flow path member 10c. The piezoelectric layer is disposed on the common electrode, and the individual electrodes are disposed on the piezoelectric layer, one for each pressure chamber 10b.

In this configuration, the second driver IC 31 receives a control signal from the controller 20, generates drive signals, and applies the drive signals to the individual electrodes. The common electrode is maintained at ground potential. The piezoelectric layer expands and contracts in the in-plane direction along with the common and individual electrodes in response to the drive signals. In accordance with this expansion and contraction, the vibration plate cooperatively deforms, thereby increasing or decreasing the volume of the pressure chamber 10b. As a result, ejection pressures are applied to the ink inside the pressure chambers 10b, and ink droplets are ejected from the nozzles 10a toward the recording medium W based on the applied ejection pressures.

Here, a conventional issue of temperature overshoot in the actuators 10d at the beginning of printing will be described. FIG. 5 is a graph illustrating an example in which the temperature of the actuators 10d overshoots. The vertical axis of FIG. 5 represents the temperature detected by the temperature sensor.

The controller 20 controls the heat generation of the heater 40 based on the temperature detected by the temperature sensor 34, so that the detected temperature approaches an initial set temperature Te, which serves as a target temperature. The controller 20 also controls the drive voltage applied to the actuators 10d based on the detected temperature.

However, after the printing has started and a certain period of time (e.g., 2 to 3 seconds) has elapsed, the actuators 10d begin to generate heat due to its operation associated with the printing. As a result, as illustrated in FIG. 5, an overshoot occurs in which the temperature of the actuators 10d exceed the initial set temperature Te.

When such an overshoot occurs, the heat generated by the actuators 10d is transferred to the ink within the flow path member 10c, causing the ink temperature to increase. Consequently, the density of ink droplets ejected immediately after the start of printing—from a relatively low-temperature flow path member 10c—differs from the density of ink droplets ejected after the ink temperature has increased due to the actuator's heat generation. This variation in droplet density leads to unevenness in the image density on the recording medium W.

To address this issue, the controller 20 executes specific processing as described below in the present disclosure.

FIG. 6 is a graph illustrating an example of the time-dependent variation of a target temperature and a temperature detected by the temperature sensor 34. In the graph of FIG. 6, the horizontal axis represents time. The zero point on the axis indicates the printing start time, and the negative time values represent time before the start of printing.

The controller 20 executes an obtaining process to obtain the temperature detected by the temperature sensor 34 before the start of printing. This allows the controller 20 to obtain the temperature of the actuators 10d prior to printing. The controller 20 then executes a determination process to determine whether a difference between the detected temperature and an initial set temperature Te, which is a predefined target temperature, is equal to or greater than a threshold value.

When the difference is less than the threshold value, the controller 20 executes a first adjustment process before the printing is started. In this process, the controller 20 causes the heater 40 to generate heat by adjusting the target temperature of the temperature sensor 34 to a first adjustment temperature T1, which is higher than the initial set temperature Te. As a result, the detected temperature of the temperature sensor 34 rises to a temperature T1a before the printing starts. That is, the ink within the flow path member 10c is heated to approximately T1a. The temperature T1a may be equal to the first adjustment temperature T1, or may be slightly higher or lower than T1.

As described above, when the difference is less than the threshold value, a relatively large temperature difference tends to occur between the ink droplets ejected immediately after the start of printing and those ejected after a certain amount of time has passed. To reduce this temperature difference, the first adjustment process is executed.

That is, even when the detected temperature is close to the initial set temperature (i.e., the difference is below the threshold value), the ink temperature may not rise sufficiently before the start of printing due to the lack of activation of the heater. This can result in a temperature difference between the early stage and later stage of printing, which may cause uneven image density. To address this, the controller executes the first adjustment process to raise the target temperature temporarily, thereby ensuring appropriate heating before printing starts.

Next, the controller 20 executes a second adjustment process after the printing has started and before it is completed. In this process, as shown in FIG. 6, the controller 20 causes the heater 40 to generate heat by adjusting the target temperature of the temperature sensor 34 to a second adjustment temperature T2, which is lower than the first adjustment temperature T1. In this case, the second adjustment process is executed after the printing starts and within a predetermined time (e.g., 2 to 3 seconds) from the start of printing.

In the second adjustment process, the controller 20 may cause the heater 40 to generate heat such that the target temperature gradually and linearly decreases from the first adjustment temperature T1 to the second adjustment temperature T2, as indicated in region Rt in FIG. 6.

As illustrated in FIG. 6, although the target temperature is set to a lower value (T2) after the start of printing, the detected temperature remains at a higher level (T1a) for a while due to the heat retained in the flow path member. This is because the heating element is deactivated at the start of printing, and the temperature of the ink gradually decreases via natural cooling. Such a temperature transition is within a tolerable range and does not negatively affect image quality.

In some implementations of the second adjustment process, the second adjustment temperature T2 may be set equal to the initial set temperature Te. In that case, the controller 20 changes the target temperature to the initial set temperature Te after the printing has started. However, the second adjustment temperature T2 is not limited to Te, and may instead be set to a value either higher or lower than the initial set temperature Te.

Alternatively, in the second adjustment process, the controller 20 may cause the heater 40 to generate heat such that the target temperature is changed from the first adjustment temperature T1 to the second adjustment temperature T2 in a stepwise manner. In this case, for example, the adjust from the first adjustment temperature T1 to the second adjustment temperature T2 may be executed in three or four discrete steps.

Further, in the second adjustment process, the controller 20 may adjust the target temperature in a stepwise manner specifically for a predetermined actuator used to eject ink droplets of a predetermined color from the nozzles 10a. As an example of such a predetermined color, yellow or cyan may be selected because density variations in these colors tend to be more visually noticeable.

By executing the second adjustment process described above, an increase in the temperature of the actuators 10d beyond T1a after a certain period of time has elapsed from the start of printing can be suppressed or prevented. In other words, this makes it easier to offset fluctuations in the temperature of the actuators 10d.

FIG. 7 is a flowchart illustrating an example of a print process executed by the liquid droplet ejection device 100. FIGS. 8A and 8B show a flowchart illustrating a subroutine of an example low-temperature print process called during the print process shown in FIG. 7.

As shown in FIG. 7, the controller 20 first determines whether a print job has been received from an external device (S1). If the print job has not been received (S1: NO), the controller 20 waits until the print job is received.

If the print job is received (S1: YES), the controller 20 then determines whether the detected temperature of the temperature sensor 34 is at a low level (S2). Specifically, in S2, the controller 20 determines whether the detected temperature of the temperature sensor 34 is lower than a predetermined value (e.g., 43° C.) . If the detected temperature is below the predetermined value (S2: YES), the controller 20 executes a low-temperature print process (S3), which includes the first and second adjustment processes described above.

In contrast, if the detected temperature is equal to or higher than the predetermined value (S2: NO), the controller 20 determines whether a predetermined time has elapsed since the completion of the printing associated with the previous print job (S4). If the predetermined time has elapsed since the completion of the previous print job (S4: YES), the controller 20 executes the low-temperature print process (S3), which includes the first and second adjustment processes. On the other hand, if the predetermined time has not elapsed since the completion of the previous print job (S4: NO), the controller 20 executes a normal print process (S5), which does not include the first and second adjustment processes in the low temperature print process.

After the execution of S5, the controller 20 determines whether the print job regarding the normal print process has been completed (S6). If the print job has been completed (S6: YES), the controller 20 terminates the process. On the other hand, if the print job has not been completed (S6: NO), the controller 20 continues executing the print job.

Next, the low-temperature print process is described. As shown in FIG. 8A, the controller 20 obtains a target temperature for the actuators 10d (S11). In this case, the controller 20 retrieves information of the initial set temperature Te, which is the target temperature stored in advance in the storage device. Then, the controller 20 starts controlling the heat generation of the heater 40 (S12). In this way, the heater 40 starts generating heat, and the heating of the ink within the flow path member 10c is started.

Next, the controller 20 determines whether the printing is to be started (S13). Specifically, the controller 20 determines whether a predetermined time has elapsed since the control of the heater 40 was started. If the predetermined time has not elapsed since the control of the heater 40 was started (S13: NO), the controller 20 obtains the detected temperature of the temperature sensor 34 (S14). Then, the controller 20 determines whether a difference between the detected temperature obtained in S14 and the target temperature obtained in S11 is equal to or greater than a threshold value (S15).

If the difference between the detected temperature and the target temperature is less than the threshold value (S15: NO), the controller 20 executes a first adjustment process (S16), in which the controller 20 changes the target temperature to a first adjustment temperature T1, which is higher than the initial set temperature Te, and causes the heater 40 to generate heat. In contrast, if the difference between the detected temperature and the target temperature is equal to or greater than the threshold value (S15: YES), or after completion of S16, the controller 20 returns to S13.

If the predetermined time has elapsed after the control of the heater 40 was started (S13: YES), the controller 20 starts the print process to cause the nozzles 10a of the ejection head 10 to eject ink droplets based on the print job (S17 of FIG. 8B).

Next, the controller 20 determines whether the predetermined time has elapsed since the printing was started (S18). If the predetermined time has elapsed (S18: YES), the controller 20 executes the second adjustment process (S19), in which the target temperature is gradually and linearly adjusted to a second adjustment temperature T2 (which is the initial set temperature Te in the present embodiment), which is lower than the first adjustment temperature T1. On the other hand, if the predetermined time has not elapsed since the printing was started (S18: NO), the controller 20 waits until the predetermined period of time elapses.

After execution of S19, the controller 20 determines whether the target temperature coincides with the initial set temperature Te (S20). If the target temperature coincides with the initial set temperature Te (S20: YES), the controller 20 determines whether the printing according to the print job has been completed (S21). On the other hand, if the target temperature does not coincide with the initial set temperature Te (S20: NO), the controller 20 returns to the processing of S19.

If the printing according to the print job is completed (S21: YES), the controller 20 terminates the control of the heater 40 and completes the second adjustment process (S22). On the other hand, if the printing according to the print job is not completed (S21: NO), the controller 20 continues the printing.

According to the liquid droplet ejection device 100 described above, if the difference between the detected temperature and the initial set temperature Te is less than the threshold value, the target temperature is adjusted to the first adjustment temperature T1, which is higher than the initial set temperature Te, and the heater 40 is caused to generate heat. In this configuration, even if the actuators 10d generate heat immediately after the start of printing, the ink within the flow path member 10c, which was already heated to the first adjustment temperature T1 by the heater 40 before the start of printing, is prevented or suppressed from being further heated due to heat generation by the actuators 10d. Accordingly, the temperature difference between ink droplets ejected immediately after the start of printing and ink droplets ejected after a lapse of time following the start of printing is reduced. Therefore, density unevenness on the recording medium W caused by a difference between the image density based on ink droplets ejected immediately after printing and the image density based on ink droplets ejected after a lapse of time is effectively suppressed.

It should be noted that the threshold value may be set based on experimental results indicating the minimum temperature difference that causes a noticeable image density variation, or may be determined based on a thermal response characteristic of the liquid droplet ejection device.

Further, in the present embodiment, since the second adjustment process is executed, the temperature of the actuators 10d is prevented from exceeding T1a after a certain period of time has elapsed since the start of printing. In other words, variation in the temperature of the actuators 10d is more likely to be offset. Therefore, the temperature difference between the ink droplets ejected immediately after the start of printing and those ejected after the lapse of time becomes smaller. As a result, density unevenness on the recording medium W, which is caused by a difference between the image density based on the ink droplets ejected immediately after the start of printing and the image density based on the ink droplets ejected after the lapse of time, is further prevented or suppressed.

In the present embodiment, the controller 20 may control the heater 40 in the second adjustment process such that the target temperature is changed stepwise from the first adjustment temperature T1 to the second adjustment temperature T2. This avoids rapid heating of the ink within the flow path member 10c, thereby facilitating the ink to reach an intended temperature.

In the present embodiment, the controller 20 may change, in a stepwise manner during the second adjustment process, the target temperature for the actuators 10d used to eject yellow and cyan inks from the first adjustment temperature T1 to the second adjustment temperature T2. In this case, density unevenness in images formed by printing with yellow and cyan inks becomes less noticeable.

In the second adjustment process according to the present embodiment, the second adjustment temperature T2 is set to the initial set temperature Te. In this case, since the temperature of the actuators 10d after the start of printing is further prevented from exceeding T1a, variations in the temperature of the actuators 10d can be more effectively cancelled out.

Further, in the present embodiment, the controller 20 terminates the control of the heater 40 after the printing based on the print job has been completed, and then ends the second adjustment process. In this case, it is avoided that the control of the heater 40 is terminated before the printing is completed, which would otherwise result in a drop in the temperature of the ink within the flow path member 10c.

Further, in the present embodiment, the controller 20 executes the first adjustment process when the detection temperature of the temperature sensor 34 is less than a predetermined temperature. Therefore, when the detection temperature of the temperature sensor 34 is equal to or greater than the predetermined temperature, that is, when the actuators 10d is in a substantially steady temperature state, the first adjustment process can be omitted.

In the present embodiment, the controller 20 executes the first adjustment process when a predetermined time period has elapsed since the completion of printing associated with the previous print job. Therefore, if the predetermined time period has not elapsed since the completion of the previous print job, that is, when the actuators 10d is in a substantially steady temperature state, the first adjustment process can be omitted.

Next, a low-temperature print process according to a second embodiment will be described. FIGS. 9A and 9B show a flowchart illustrating a subroutine of another example of the low-temperature print process called during the print process shown in FIG. 7.

As illustrated in FIG. 9A, the controller 20 initially obtains the target temperature for the actuators 10d (S31). Next, the controller 20 starts controlling the heat generation of the heater 40 (S32). In this manner, heat generation by the heater 40 begins, and the ink within the flow path member 10c starts to be heated.

Next, the controller 20 determines whether printing is to be started (S33). Specifically, the controller 20 determines whether a predetermined period of time has elapsed since the control of the heater 40 was started. If the predetermined period has not yet elapsed (S33: NO), the controller 20 obtains the detected temperature from the temperature sensor 34 (S34). Then, the controller 20 determines whether the difference between the detected temperature and the target temperature obtained in S31 is equal to or greater than a threshold value (S35).

If the difference between the detected temperature and the target temperature is less than the threshold value (S35: NO), the controller 20 executes a first adjustment process (S36), in which the target temperature is adjusted to the first adjustment temperature T1, which is higher than the initial set temperature Te, to cause the heater 40 to generate heat. In contrast, if the difference between the detected temperature and the target temperature is equal to or greater than the threshold value (S35: YES), or after the execution of S36, the controller 20 returns to the processing of S33.

On the other hand, if the predetermined period of time has elapsed since the control of the heater 40 was started (S33: YES), the controller 20 starts a printing operation based on the print job, in which ink droplets are ejected from the nozzles 10a of the ejection head 10 (S37 of FIG. 9B).

Next, the controller 20 determines whether a predetermined period of time has elapsed since the printing was started (S38). If the predetermined time has not yet elapsed (S38: NO), the controller 20 waits until the predetermined period of time elapses. On the other hand, if the predetermined time has elapsed (S38: YES), the controller 20 obtains the number of nozzles to be used based on the image data in the print job (S39). Then, based on the obtained number of nozzles to be used, the controller 20 executes a second adjustment process in which the target temperature is adjusted to a second adjustment temperature T2 that is lower than the first adjustment temperature T1, thereby causing the heater 40 to generate heat (S40). In this case, if the number of nozzles to be used is less than a threshold value, the amount of residual ink in the flow path member 10c tends to be larger than when the number of nozzles to be used is equal to or greater than the threshold value. Accordingly, in the second adjustment process, the controller 20 may set the second adjustment temperature T2 to a temperature lower than the initial set temperature Te. In contrast, if the number of nozzles to be used is equal to or greater than the threshold value, the controller 20 may set the second adjustment temperature T2 to the initial set temperature Te in the second adjustment process.

After execution of S40, the controller 20 determines whether the target temperature coincides with the initial set temperature Te (S41). If the target temperature coincides with the initial set temperature (S41: YES), the controller 20 determines whether the print process for the print job has been completed (S42). On the other hand, if the target temperature does not coincide with the initial set temperature Te (S41: NO), the controller 20 returns to the processing of S40.

If the printing for the print job has been completed (S42: YES), the controller 20 terminates the control of the heater 40 and also terminates the second adjustment process (S43). On the other hand, if the printing for the print job has not yet been completed (S42: NO), the controller 20 continues the printing.

As described above, in the present embodiment, the controller 20 adjusts the target temperature by changing it to the second adjustment temperature based on the number of nozzles to be used, in the second adjustment process. In this case, the second adjustment temperature T2 can be determined according to the number of nozzles to be used. For example, if the number of nozzles to be used is less than a threshold value, it is assumed that the amount of residual ink in the flow path member 10c is relatively large. Therefore, in such a case, the second adjustment temperature T2 may be set to a temperature lower than the initial set temperature Te. On the other hand, if the number of nozzles to be used is equal to or greater than the threshold value, it is assumed that the amount of residual ink in the flow path member 10c is relatively small. Therefore, in such a case, the second adjustment temperature T2 may be set to the initial set temperature Te. In this way, the second adjustment temperature T2 can be appropriately determined according to the number of nozzles to be used.

Next, a print process according to a third embodiment will be described with reference to a flowchart. FIG. 10 is a flowchart illustrating another example of a print process executed by the liquid droplet ejection device 100.

As shown in FIG. 10, the controller 20 determines whether a print job has been received from an external device (S51). If the print job has not been received (S51: NO), the controller 20 waits until the print job is received.

If the print job has been received (S51: YES), the controller 20 then determines whether a print ratio on the recording medium W will be equal to or greater than a predetermined value (S52) before starting the printing. Here, the print ratio represents a ratio of an area on which an image is formed to an area on which an image can be formed on the recording medium W. If the print ratio on the recording medium W will be equal to or greater than the predetermined value (S52: YES), the controller 20 executes the low-temperature print process including the first adjustment process and the second adjustment process (S53).

If the print ratio on the recording medium W will be less than the predetermined value (S52: NO), the controller 20 executes the normal print process (S54). After execution of S54, the controller 20 determines whether the print job regarding the normal print process has been completed (S55). When the print job has been completed (S55: YES), the controller 20 terminates the process. On the other hand, when the print job has not yet been completed (S55: NO), the controller 20 continues executing the print job.

As described above, in the present embodiment, the controller 20 executes the first adjustment process when the print ratio on the recording medium W will be equal to or greater than a predetermined value. When the print ratio will be equal to or greater than the predetermined value, density unevenness is more likely to occur than when the print ratio will be less than the predetermined value. Therefore, by executing the first adjustment process in such a case, the occurrence of density unevenness can be effectively suppressed.

Next, a low-temperature print process according to a fourth embodiment will be described with reference to flowcharts. FIGS. 11A and 11B show a flowchart illustrating a subroutine representing another example of the low-temperature print process called in the print process shown in FIG. 7. FIG. 12 is a flowchart illustrating a subroutine representing an example of a continuing process called in FIG. 11B.

As shown in FIG. 11A, the controller 20 first obtains the target temperature for the actuators 10d (S61). Then, the controller 20 starts controlling the heat generation of the heater 40 (S62). As a result, the heater 40 begins to generate heat, thereby initiating the heating of the ink within the flow path member 10c.

Next, the controller 20 determines whether printing is to be started (S63). Specifically, the controller 20 determines whether a predetermined period of time has elapsed since the start of control of the heater 40. If the period has not yet elapsed (S63: NO), the controller 20 obtains the temperature detected by the temperature sensor 34 (S64). Then, the controller 20 determines whether the difference between the detected temperature and the target temperature obtained in S61 is equal to or greater than a threshold value (S65).

If the difference between the detected temperature and the target temperature is less than the threshold value (S65: NO), the controller 20 executes the first adjustment process (S66), in which the target temperature is changed to the first adjustment temperature T1, which is higher than the initial set temperature Te, and the heater 40 is caused to generate heat. In contrast, if the difference is equal to or greater than the threshold value (S65: YES), or after completion of the process in S66, the controller 20 returns to the processing of S63.

On the other hand, if a predetermined period of time has elapsed since the control of the heater 40 was started (S63: YES), the controller 20 starts the printing operation in which ink droplets are ejected from the nozzles 10a of the ejection head 10 based on the print job (S67).

Next, the controller 20 determines whether a predetermined period of time has elapsed since the printing was started (S68 of FIG. 11B). If the predetermined period has elapsed (S68: YES), the controller 20 executes the second adjustment process (S69), in which the controller 20 adjusts the target temperature by changing it to the second adjustment temperature T2, which is lower than the first adjustment temperature T1, and causes the heater 40 to generate heat. On the other hand, if the predetermined period has not yet elapsed since the printing was started (S68: NO), the controller 20 waits until the predetermined period of time elapses.

After execution of S69, the controller 20 determines whether the target temperature has been adjusted to match the initial set temperature Te (S70). If the target temperature matches the initial set temperature Te (S70: YES), the controller 20 determines whether the printing according to the print job has been completed (S71). On the other hand, if the target temperature does not yet match the initial set temperature Te (S70: NO), the controller 20 returns to the processing of S69.

When the printing regarding the print job has been completed (S71: YES), the controller 20 determines whether a subsequent print job is available (S72). On the other hand, if the printing regarding the print job has not been completed (S71: NO), the controller 20 continues the printing.

If the controller 20 determines that the next print job is available (S72: YES), the controller 20 executes a continuing process (S73), which will be described below. Then, after completion of the continuing process, the controller 20 terminates the control of the heater 40 (S74) and completes the second adjustment process. On the other hand, if no subsequent print job is available (S72: NO), the controller 20 terminates the control of the heater 40 (S74) and completes the second adjustment process.

The continuing process is now described. As shown in FIG. 12, the controller 20 first determines whether a difference between the detected temperature and the target temperature is equal to or greater than a threshold value (S81). If the difference is less than the threshold value (S81: NO), the controller 20 determines whether the print ratio for the next print job on the recording medium W will be equal to or greater than a predetermined value (S82). If the print ratio will be equal to or greater than the predetermined value (S82: YES), the controller 20 executes the second adjustment process in which the controller 20 adjusts the target temperature to the second adjustment temperature T2, which is lower than the first adjustment temperature T1, in a non-stepwise (i.e., linear) manner, and the controller 20 also causes the heater 40 to generate heat (S83). On the other hand, if the print ratio will be less than the predetermined value (S82: NO), the controller 20 executes the second adjustment process in which the controller 20 adjusts the target temperature to the second adjustment temperature T2, which is lower than the first adjustment temperature T1, in a stepwise manner, and the controller 20 causes the heater 40 to generate heat (S85).

If the difference between the detected temperature and the target temperature is equal to or greater than the threshold value (S81: YES), or after the execution of either S83 or S85, the controller 20 determines whether the printing is to be started (S84). If it is determined that the printing is to be started (S84: YES), the controller 20 returns to the processing of S67. On the other hand, if it is determined that the printing is not to be started (S84: NO), the controller 20 waits until the printing is started.

As described above, in the present embodiment, when a subsequent print job (i.e., a second print job) follows a previous print job (i.e., a first print job) which is an immediately preceding print job, and a difference between the detected temperature and the target temperature after the end of the first print job is equal to or greater than a threshold value, the controller 20 starts printing for the second print job after the end of the first print job. In this manner, when the difference between the detected temperature and the target temperature after the end of the first print job is equal to or greater than the threshold value—i.e., when the temperature of the ink in the flow path member 10c has not significantly changed—the first adjustment process can be omitted, and printing for the second print job can be continued immediately following the printing for the first print job. Accordingly, since the first adjustment process can be omitted, the total processing time can be reduced.

Further, in the present embodiment, when there is a second print job following the first print job, and the difference between the detected temperature and the target temperature after completion of the first print job is less than the threshold value, and the print ratio on the recording medium will be equal to or greater than the threshold value, the controller executes the first adjustment process before starting printing for the second print job. In this manner, when the difference between the detected temperature and the target temperature after completion of the first print job is less than the threshold value—that is, when the temperature of the ink in the flow path member 10c has significantly changed—and the print ratio will be equal to or greater than the threshold value, the target temperature is rapidly raised toward the first adjustment temperature T1 in the first adjustment process. As a result, the ink within the flow path member 10c can be quickly heated as compared to the case where the target temperature is raised toward the first adjustment temperature T1 in a stepwise manner in the first adjustment process, and density unevenness in the printing for the subsequent print job can be suppressed.

Further, in the present embodiment, when a second print job follows the first print job, and the difference between the detected temperature and the target temperature after completion of the first print job is less than the threshold value, and the print ratio on the recording medium will be less than the threshold value, the controller gradually changes the target temperature from the initial set temperature to the first adjustment temperature before starting printing for the second print job in the first adjustment process. In this manner, when the difference between the detected temperature and the target temperature after completion of the first print job is less than the threshold value—that is, when the temperature of the ink in the flow path member 10c has significantly changed—and the print ratio will be less than the threshold value, the target temperature is gradually raised toward the first adjustment temperature T1 in the first adjustment process. This avoids excessive heating of the ink in the flow path member 10c and suppresses density unevenness in the printing associated with the subsequent print job.

While aspects of the present disclosure have been described in conjunction with various example structures outlined above and illustrated in the figures, various alternatives, modifications, variations, improvements, and/or substantial equivalents, whether known or presently unforeseen, may become apparent to those having at least ordinary skill in the art. Accordingly, the example embodiments set forth above are intended to be illustrative of the present disclosure, and not limiting. Various changes may be made without departing from the spirit and scope of the present disclosure. Therefore, the present disclosure is intended to embrace all known or later developed alternatives, modifications, variations, improvements, and/or substantial equivalents. Some specific examples of potential alternatives, modifications, or variations in the described aspects of the present disclosure are as follows.

In the above-described embodiments, the target temperature is adjusted to the second adjustment temperature T2, which is lower than the first adjustment temperature T1, based on the number of nozzles to be used during the second adjustment process. However, this is not the only applicable approach. Alternatively, the target temperature may be adjusted to the second adjustment temperature T2 based on the number of ink droplet ejections from the nozzles 10a during the second adjustment process. In another variation, the target temperature may be adjusted to the second adjustment temperature T2 based on both the number of nozzles to be used and the number of ejections.

The first adjustment process is a control operation executed before the start of printing, in which the target temperature is temporarily increased and the heater is actively driven when the temperature of the flow path member (or the area around the actuators) is not sufficiently elevated. This process is intended to rapidly raise the temperature of the ink.

The second adjustment process, on the other hand, is a control operation that anticipates a temperature increase caused by heating of the actuators, and reduces the heating by the heater by setting the target temperature to a lower level accordingly.

In the above-described embodiments, a plurality of line heads 71 are provided. However, the present disclosure is not limited to this configuration. A single line head 71 may instead be employed. Alternatively, a plurality of ejection heads 10 may be provided without including the line head 71.

According to aspects of the present disclosure, when a difference between the detected temperature and the initial set temperature is less than a threshold value, the target temperature is adjusted to a first adjustment temperature that is higher than the initial set temperature, and the heat generating member is caused to generate heat before the start of printing. Therefore, even if the actuators generate heat immediately after printing starts, heating of the liquid droplets within the flow path member caused by the actuators can be suppressed or prevented, since the droplets have already been heated by the heat generating member to the first adjustment temperature prior to the start of printing. As a result, a temperature difference between ink droplets ejected immediately after printing starts and those ejected after some time has elapsed from the start of printing is reduced. Consequently, density variation on the recording medium W, which may result from a difference in image density between an image formed by the ink droplets ejected immediately after printing starts and an image formed by the ink droplets ejected after time has passed, can be suppressed.

What is claimed is

1. A liquid droplet ejection device, comprising:
an ejection head including a flow path member and a plurality of actuators, the flow path member being formed with a plurality of nozzles, liquid droplets being ejected from the plurality of nozzles toward a recording medium, a plurality of pressure chambers that communicate with the plurality of nozzles, the plurality of actuators being disposed on an upper surface of the flow path member and configured to apply ejection pressure to the liquid within the pressure chambers;
a frame member disposed on a side opposite to the flow path member with respect to the actuators;
a heat generating member accommodated in the frame member and configured to generate heat;
a temperature sensor configured to detect a representative temperature indicative of a temperature of the actuators as a whole; and
a controller configured to:
obtain the representative temperature detected by the temperature sensor;
determine whether a difference between the representative temperature and an initial set temperature, which is a predetermined target temperature, is equal to or greater than a threshold value; and
when the difference is less than the threshold value, execute a first adjustment process, in which the controller performs:
adjusting the target temperature by changing the target temperature to a first adjustment temperature, the first adjustment temperature being higher than the initial set temperature; and
causing the heat generating member to generate heat before printing starts.

2. The liquid droplet ejection device according to claim 1,
wherein, after the start and before the completion of printing, the controller is further configured to execute a second adjustment process, in which the controller performs:
adjusting the target temperature by changing the target temperature to a second adjustment temperature, the second adjustment temperature being lower than the first adjustment temperature; and
causing the heat generating member to generate heat.

3. The liquid droplet ejection device according to claim 2,
wherein the controller is configured, in the second adjustment process, to adjust the target temperature from the first adjustment temperature to the second adjustment temperature in a stepwise manner.

4. The liquid droplet ejection device according to claim 3,
wherein the controller is configured, in the second adjustment process, to change, in a stepwise manner, the target temperature for a predetermined actuator, among the actuators, used for ejecting a liquid of a predetermined color from the first adjustment temperature to the second adjustment temperature.

5. The liquid droplet ejection device according to claim 2,
wherein the controller is configured, in the second adjustment process, to adjust the target temperature to the second adjustment temperature based on the number of nozzles to be used among the nozzles.

6. The liquid droplet ejection device according to claim 2,
wherein, in the second adjustment process, the second adjustment temperature is the initial set temperature, and
wherein the controller is configured, after the start of printing, to adjust the target temperature to the initial set temperature in the second adjustment process.

7. The liquid droplet ejection device according to claim 2,
wherein the controller is configured to cause the ejection head to eject liquid droplets based on a first print job, and to terminate the second adjustment process after completion of the first print job.

8. The liquid droplet ejection device according to claim 1,
wherein the controller is configured to execute the first adjustment process before printing is started when the representative temperature is less than a predetermined temperature.

9. The liquid droplet ejection device according to claim 1,
wherein the controller is configured to execute the first adjustment process when a predetermined time period has elapsed since completion of an immediately preceding print job.

10. The liquid droplet ejection device according to claim 1,
wherein the controller is configured to:
determine whether a print ratio of an image portion to be printed on the recording medium is equal to or greater than a predetermined value; and
execute the first adjustment process when the print ratio on the recording medium is determined to be equal to or greater than a predetermined value.

11. The liquid droplet ejection device according to claim 2,
wherein, when a second print job follows a first print job and a difference between the detected temperature and the target temperature after completion of the first print job is equal to or greater than a predetermined threshold value, the controller is configured to start printing based on the second print job after completion of the first print job.

12. The liquid droplet ejection device according to claim 2,
wherein the controller is configured to:
determine whether a print ratio of an image portion to be printed on the recording medium is equal to or greater than a predetermined value; and
when a second print job follows the first print job, and a difference between the detected temperature and the target temperature after completion of the first print job is less than a predetermined threshold value, and a print ratio on the recording medium in the second print job is determined to be equal to or greater than a predetermined value, execute the first adjustment process before starting printing based on the second print job.

13. The liquid droplet ejection device according to claim 2,
when a second print job follows the first print job, a difference between the detected temperature and the target temperature after completion of the first print job is less than a predetermined threshold value, and the print ratio of an image portion on the recording medium is determined to be less than a predetermined value, execute the first adjustment process to adjust the target temperature from the initial set temperature to the first adjustment temperature in a stepwise manner before starting printing based on the second print job.

14. A liquid droplet ejection method using a liquid droplet ejection device including an ejection head including a flow path member and a plurality of actuators, the flow path member being formed with a plurality of nozzles, liquid droplets being ejected from the plurality of nozzles toward a recording medium, a plurality of pressure chambers that communicate with the plurality of nozzles, the plurality of actuators being disposed on an upper surface of the flow path member and configured to apply ejection pressure to the liquid within the pressure chambers, a frame member disposed on a side opposite to the flow path member with respect to the actuators, a heat generating member accommodated in the frame member and configured to generate heat, and a temperature sensor configured to detect a representative temperature indicative of a temperature of the actuators as a whole, the method, comprising:
obtaining a detected temperature detected by the temperature sensor;
determining whether a difference between the detected temperature and an initial set temperature, which is a predetermined target temperature, is equal to or greater than a threshold; and
when the difference is less than the threshold, adjusting the target temperature by changing the target temperature to a first adjustment temperature that is higher than the initial set temperature, and causing the heat generating member to generate heat before printing starts.

15. A non-transitory computer-readable storage medium for a liquid droplet ejection device having an ejection head including a flow path member and a plurality of actuators, the flow path member being formed with a plurality of nozzles, liquid droplets being ejected from the plurality of nozzles toward a recording medium, a plurality of pressure chambers that communicate with the plurality of nozzles, the plurality of actuators being disposed on an upper surface of the flow path member and configured to apply ejection pressure to the liquid within the pressure chambers, a frame member disposed on a side opposite to the flow path member with respect to the actuators, a heat generating member accommodated in the frame member and configured to generate heat, and a temperature sensor configured to detect a representative temperature indicative of a temperature of the actuators as a whole,
wherein the non-transitory computer-readable storage medium contains computer-executable instructions which cause, when executed by a computer of the liquid droplet ejection device, the liquid droplet ejection device to execute:
obtaining a detected temperature detected by the temperature sensor;
determining whether a difference between the detected temperature and an initial set temperature, which is a predetermined target temperature, is equal to or greater than a threshold; and
when the difference is less than the threshold, adjusting the target temperature by changing the target temperature to a first adjustment temperature that is higher than the initial set temperature, and causing the heat generating member to generate heat before printing starts.
